(19) United States
(12) Patent Application Publication
(10) Pub. No.: US 2013/0070466 A1
(43) Pub. Date: Mar. 21, 2013

(54) METHOD AND SYSTEM FOR MANUFACTURING AND DEPLOYING HIGHLY EFFICIENT LIGHT EMITTING DIODE AND COMMUNICATIONS TECHNOLOGIES

(71) Applicant: JOHN N. O'BRIEN, St. Augustine, FL (US)

(72) Inventor: JOHN N. O'BRIEN, St. Augustine, FL (US)

(21) Appl. No.: 13/423,590

(22) Filed: Mar. 19, 2012

Related U.S. Application Data
(60) Provisional application No. 61/453,788, filed on Mar. 17, 2011.

(51) Int. Cl. F21V 21/00; F21V 29/00

(52) U.S. Cl. 362/382

(57) ABSTRACT

The present invention relates to the development of a method and system for manufacturing and deploying light emitting diode (“LED”) technology in a highly efficient manner. Devices of the invention include a printed circuit board with a heat sink and at least one LED insertion site and optionally a wireless communication device to control operation of the LED.

### CROSS-REFERENCE TO RELATED APPLICATION

This application claims the benefit of U.S. Provisional Application Ser. No. 61/453,788, filed Mar. 17, 2011, the contents of which are hereby incorporated by reference herein in their entirety.

### FIELD OF THE INVENTION

The present invention relates to the development of a method and system for manufacturing and deploying light emitting diode (“LED”) technology in a highly efficient manner. The efficiency is enhanced by the use of printed circuit boards, advanced heat sink technology and high output LEDs.

### BACKGROUND OF THE INVENTION

Over the past ten years, LEDs have gone from being dimly lit indicators on kitchen appliances, to high intensity, energy saving power devices capable of providing illumination to entire cities. There are very few lighting applications in which LEDs will not be able to replace existing lighting systems, and do so while providing higher quality light using less than half the power. LED-equipped fixtures generate less heat than standard lighting fixtures, thus reducing the HVAC costs. Additionally, with an estimated 50,000 to 200,000 hour life expectancy or more and any extended life expectancy, labor associated with the replacement of standard bulbs, metal halides, induction technology, fluorescent tubes and required ballasts are significantly reduced. LEDs also provide an additional “green” component in that they have no mercury or other hazardous material in them like fluorescent tubes, metal halides, induction technology and the related ballasts that must be used. Thus the disposal of LEDs at the end of their life cycle does not introduce this harmful elements and chemicals into our landfills the way many other lighting systems do.

The invention may be used for retrofit for any existing lighting application or new fixtures for indoor lighting, outdoor lighting such as common areas and parking lots, marine lighting, off-grid power and lighting, security systems, multimedia applications, photography, religious lighting, medical or therapeutic applications, outreach and disaster applications, among others. Many environments are not connected to any integrated electric grid system. In fact more than two thirds of the world's population are not connected to an electric grid and are, therefore, “off-grid”. The invention can be used in an integrated or non-integrated manner to provide light and power to off-grid areas.

### SUMMARY OF THE INVENTION

The system and method is for a design and manufacturing of a printed circuit board with insertion sites for LEDs and a surface heat sink that is then attached to the printed circuit board to dissipate heat that is generated by the LEDs once illuminated. The heat sink can be highly polished and used as a reflector in and solar energy applications. The printed circuit board may be ridged, flexible, static, dynamic and configured in various ways to accommodate the LEDs and the external heat sink so that the LEDs can generate light and the overall temperature of the system does not rise to the point when the system can be damaged by the heat generated by the LEDs. The printed circuit board may be configured in to “strips” or “sticks”, rectangular, trapezoidal, circular, sphere, cylindrical, or other shape that may be less than 1 nanometer to 1000 meters in length and less than 1 nanometer to 1000 meters in width. The system may contain an integrated “driver” (i.e., transformer/power supply) which converts alternating current electric supply into direct current suitable to power LEDs. The system can also be operated on a DC battery, batteries solar panels, fuel cells or other power sources. Several types of drivers may be employed in different configurations. The LEDs may be configured into various circuits including in series or parallel. In addition, the strips, sticks or other shapes may be coupled with fixtures so that they can be interconnected directly without the use of wires or may be subject to a wiring harness.

### DETAILS OF THE INVENTION

The printed circuit board may be less than 1 nanometer to 1000 meters in length and less than 1 nanometer to 1000 meters in width and have sites to insert LEDs. It may also contain an integrated driver mounted on the circuit board or may use and external driver. The driver used may utilize telemetry for additional functionality. The additional functionality may include advance warnings of failure of the system or the LEDs, details of the heat levels that are present in the system, providing “Wi-Fi” capabilities, including any radio or optic technology including wired or wireless, radio and network repeaters, integration of solar or other forms of electric generation, energy storage systems, provision for remote controlled adjustment of current or voltage, remote dimming, and the properties of semiconductor(s) junction for communication, the use of the LEDs themselves for communications, using optics as a sensory device, among other capabilities. The circuit board may utilize digital or analogue resistors to assist the system in regulating the current. The heat sink may be passive in nature, configured with fins to dissipate heat or may utilize an integrated fan or other air moving device. Heat sinks with LEDs are discussed in U.S. Pub. 2010/0144648; U.S. Pub. 2009/0116252; and U.S. Pub. 2004/0264195, the contents of which are hereby incorporated by reference in their entirety.

The strips, sticks or other shaped circuit boards may be used to replace fluorescent bulbs, incandescent bulbs, metal halide bulbs, ballasts, induction lighting, and any other type of lighting technology. Incandescent replacements and circuits are discussed in U.S. Pub. 2008/0130288, the contents of which are hereby incorporated by reference in their entirety. The strips, sticks or other shapes may be aligned in a linear fashion or side-by-side depending on the application. Strip structures are described in U.S. Pat. No. 5,848,837, the contents of which are hereby incorporated by reference in their entirety. The driver can be used for dimming or setting lighting levels as appropriate including microcontrollers, self-reliant circuitry and other processing functions. A thin LED is discussed in U.S. Pub. 2008/0151543, the contents of which are hereby incorporated by reference in their entirety.

The circuit board may also have the capability to emit light from both sides of the system. It may be used for decorative purposes, signage lighting, emergency lighting, street lighting, garage lighting, clothing applications (e.g., for safety personnel such as uniforms and finger lights) and other applications (see, e.g., U.S. Pub. 2006/0035511, the contents of which are hereby incorporated by reference in their entirety for all purposes). It may also include embedded or external optical adjustments or filters. The strips, sticks or other shapes may also be canted on angles to enhance light dispersion. The strips or sticks may also be equipped with magnets to affix the strips into a fixture or may utilize a fixative such as glue, paste, vacuums, vectors, velocities or other means.

In certain embodiments, the invention provides a lighting device with Wi-Fi enabled communication capabilities. A Wi-Fi enabled lighting device can connect to the internet or to a local area network (LAN) using a wireless connection. Wireless connection of LED devices is discussed in U.S. Pat. No. 7,606,602; U.S. Pub. 2010/0271802; and U.S. Pub. 2010/0141153, the contents of which are hereby incorporated by reference in their entirety. A Wi-Fi enabled device such as a personal computer, video game console, smartphone, or digital audio player can connect to the Internet when within range of a wireless network connected to the Internet. The coverage of one or more (interconnected) access points—called hotspots when offering public access—generally comprises an area the size of a few rooms but may be expanded to cover many square miles, depending on the number of access points with overlapping coverage.

In certain embodiments the invention provides an apparatus including a PCB, a heat sink, an LED, a resistor, and a Wi-Fi device operably connected to detect a present state of the apparatus and communicate over a network with a computer. The PCB may optionally include any combination of rheostat; diode; PIN diode; photovoltaic cell; fan; motor; infrared detector or transmitter; RF antenna; switch; processor; digital camera or video camera; chime; memory (e.g., flash memory chip or connected hard drive); bus or connections; data connector (e.g., RJ 45 jack); battery; motor; power connection; connections to other PCBs; or non-LED (e.g., incandescent) light receptacle. A computer generally includes a memory, processor, and input/output device, connected by a bus. Exemplary input/output devices include keyboard, pointer (e.g., mouse or trackpad), and Wi-Fi card; touchscreen and Wi-Fi card or cellular RF antenna; Ethernet jack (e.g., for 10/100 network communication via an RJ45 connection); USB port; USB port with internet via USB adapter device; or any combination of the foregoing. Exemplary computers include laptops, desktop PCs or Macs, tablets and smart phones.

In certain embodiments, the apparatus includes a rheostat or similar controller to control a brightness or state of an LED.

In some embodiments, circuitry within the apparatus detects a present failure state of the apparatus and communicates a present failure state over a network to a computer. An operator may receive information about a present state via a computer program, for example, through a web browser, custom program, shell prompt, or app.

In some embodiments, an operator may interact with a computer, using a computer program, and cause a command to be issued to affect operation of the apparatus. Exemplary operations that can be initiated in an apparatus via a command include power on; power off; brighter; dimmer; override on-chip commands (e.g., emergency power on); bypass resistor; change resistance; logic operation (e.g., if X, then Y); save (i.e., save data to file in memory); emit sound; operate motor (run, stop, faster, slower, change torque, change gears, etc.); and record image(s).

In certain embodiments, the invention provides a computer program including instructions and stored on a tangible, non-transitory computer readable medium. The program is available to be accessed by a user and copied from a server computer to a computer device (e.g., local computer or smart phone). A user may copy the program to the computer device and run the program. The program issues commands that cause a processor on the device to communicate via a network (preferably including a wireless component) with an apparatus including an LED. For example, a user may download an app to a smartphone (or an application to a computer) and use it to control one or more LED lighting apparatuses that are installed in their home or business. By interacting with the app or application, the user may operate an LED lighting apparatus. Operating a lighting apparatus can include: turn on; turn off; program on or off time (one time or recurring); set brightness level; program conditional on/off (e.g., if garage door does not open, then turn on living room light at 6:15 pm); read/write commands (e.g., save estimated kW h consumption to file daily); and other similar operations.

In certain embodiments, an apparatus detects a failure state of an LED lighting device. An apparatus can communicate a failure state via a network to a user (e.g., send signal from Wi-Fi card to household Wi-Fi hotspot, through internet connection to server operated by server provider company, retransmitted as data signal over 3G cell network and received at smartphone as information alert through program app). An apparatus can be configured to optionally turn on an alternative light source (e.g., backup incandescent light) responsive to a failure or receive program instructions from a user program to turn on an alternative light source.

In some embodiments, systems of the invention include one or more of an LED lighting device installed (“local system”) and communicably coupled to a network as well as a program installed on a computer and communicably coupled over one or more of a network to the local system. A user controls aspects of the local system from the computer. In certain embodiments, the computer is a smartphone (e.g., iPhone, Samsung Galaxy with Android, Blackberry, or similar) and the program is an app. As used herein, app generally refers to a program installed on a small handheld device (e.g., with a touchscreen) and application generally refers to a program installed on a laptop or PC (e.g., with a keyboard and pointer). In certain embodiments, the computer is a laptop or PC and the program is an application. The system controls illumination via LED apparatuses, and optionally turns on secondary apparatuses as-needed, such as, for example, turning on incandescent or fluorescent light fixtures upon failure of an LED apparatus; operating fan, heater, AC, or HVAC equipment depending on weather; opening or closing a door, window, or garage door; locking or unlocking a lock; or turning on/off an invisible fence.

In certain aspects, the invention provides a safety system that includes an apparatus having a PCB with at least one LED and a network connection. In some embodiments, the apparatus includes a very bright, highly visible LED and is configured to be off by default. Subject to certain conditions, the LED is turned on. For example, in some embodiments, the apparatus is included in a badge connected to a pet's collar. The apparatus includes a PCB with a heat sink, at least one LED, a battery, a cellular RF antenna, and optionally a photovoltaic cell. The LED is off by default. The cellular RF antenna polls the cell network (e.g., exchanges a signal with a sector of an available cell tower) periodically (e.g., per hour, irregularly, per six hours, or per millisecond). The RF antenna in the apparatus transmits a query signal, which the tower relays to a system computer (e.g., server). The system computer responds by a sending an “all clear” signal which is relayed back to the apparatus. Upon receipt of the “all clear” signal, the apparatus does nothing (i.e., maintains a dark state, or off state). When a user (e.g., human) ascertains that their pet is lost, the user operates a computer program on a user computer to set a status setting to “lost”. If the system computer and the user computer are not the same, the user computer transmits the effective status setting (“lost”) to the system computer. After receipt of the “lost” effective status setting, upon receipt of the query signal from the collar apparatus, the system computer does not send an “all clear” signal. The system computer instead sends either nothing or a lost signal. When the collar apparatus fails to receive an “all clear” signal, it triggers the operation of the LED, causing it to illuminate.

Due to the fact that the LED only remains dark if it successfully receives an “all clear” signal, the safety system has a built in failsafe in that, if the apparatus is out of range of any cell tower, the illumination will be triggered (i.e., the LED will be turned on). Under operation of the safety system, a pet may generally have a non-descript collar with a small apparatus connected (e.g., small plastic badge form factor). However, if the pet escapes a house, car, or leash, a person may trigger operation of the system, invoking significant two-fold safety protection. Due to the brightly lit LED, the pet will be easier to find, but will also be easier for a driver to see at night, thereby significantly decreasing the likelihood of accident and injury.

In certain aspects, the invention provides a lighting apparatus that includes a printed circuit board, a heat sink, and at least one LED, in which the lighting apparatus has a form factor to replace a fluorescent light bulb and includes one or more bi pin connection. The printed circuit board includes a resistor. In certain embodiments, the printed circuit board further includes circuitry to balance power demands so that the lighting apparatus can be used within a standard T12 fixture without bypassing the ballast. Thus a user may obtain one or more lighting apparatus of the invention and replace an existing T12 fluorescent bulb with the apparatus with no further modification of existing hardware.

In certain embodiments, the printed circuit board includes a wireless communication device and optionally a microprocessor to enable operation of at least one LED on the board wireless. For example, by including a wireless connection, LED, heat sink, resistor, and optionally a processor in T12 replacement form factor, a bulb can be provided that can be programmed or operated remotely. A bulb can be turned on or off through use of an app on a smart phone. A bulb's present status (e.g., failure) can be received by a computer and saved to a file or accessed by a user. In some embodiments, the invention provides a system including a plurality of T12 replacement bulbs communicably coupled to a computing device. The status of the bulbs can be monitored by a central computer or the bulbs can be operated by the central computer. Use the system can offer building-wide or campus-wide lighting control or maintenance. An operator can control or monitor the lighting system throughout an entire building or campus from a single position at a computer.

Due to the fact that the wireless operation and communication is provided within the T12 replacement bulb form-factor, no retrofitting is required to an existing building structure or lighting fixture. An LED T12 replacement can include Wi-Fi or cell (e.g., 3G or 4G) connections and can simply be put into T12 fixtures throughout a building or campus. As offered by a provider (or custom-configurable), they will begin receiving commands or sending status over the wireless network to a computer device.

Due to the fact that the LED-based T12 replacement bulbs include wireless communication or power balancing circuitry within, a user may switch existing light fixtures to low-power, computer controlled fixtures by only replacing the bulbs (i.e., without buying numerous additional components such as new fixtures, dimmers, timers, etc.). A user can replace existing bulbs with wireless enabled LED T12 s and install an app or application onto a computer device with a memory and a processor and the exert computer control over lighting. In a building-wide or campus-wide deployment, the system offers significant benefits in terms of lowered maintenance costs (e.g., due to the longevity inherent in LEDs as compared to traditional fluorescent fixtures) and significant benefits in terms of power savings (ability to turn unneeded lights off easily from a central location) and significant benefits in terms of security (can make any/all buildings on campus or rooms in building appear occupied due to unpredictable on/off switching). Control of the system can be transferred from facilities maintenance to security or police on an as-needed basis. Computer controlled lighting systems allow control in a groups and permissions style. For example to illustrate, in a family household, children may be able to turn lights on and off, but a parent can override that control on an as-needed basis and turn all bedroom light off, or all yard lights on, for example. In, for example, a retirement home deployment, occupants can control lights in private rooms and common areas, but medical professionals can have overriding control abilities in an emergency.

In certain aspects, the invention provides a lighting apparatus that includes a printed circuit board with at least on LED light and an RF antenna and circuitry to control operation of the LED via communication through the RF antenna. The RF antenna may operate via communication with a computer device such as a smartphone. In various embodiments, operation of the LED via a computer device may be either direct or indirect (i.e., over a cell network). In indirect mode, the lighting apparatus receives commands through the antenna from a sector of a cell tower which communicates in-turn with a phone via a cell network.

In direct mode, the lighting apparatus communicates by sending and receiving RF signals between the RF antenna and an RF antenna within a mobile phone computing device. In this mode, the invention provides a light for which a phone operates as a remote control.

In some embodiments, a user is not aware of whether a system including the apparatus and the mobile phone is operating in direct or indirect mode. If the user is within the same area (e.g., room, building, i.e., within RF “reach”), the devices communicate directly. If the user is distal (e.g., other city or state), the devices communicate via a cell network. In some embodiments, the invention provides an app to be installed on the phone computer device. Operation of the lighting apparatus can be programmed via the app (i.e., on and off at certain times, etc.).

### Incorporation by Reference

References and citations to other documents, such as patents, patent applications, patent publications, journals, books, papers, web contents, have been made throughout this disclosure. All such documents are hereby incorporated herein by reference in their entirety for all purposes.

### Equivalents

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A lighting device comprising:
a printed circuit board;
a heat sink; and
an insertion site for an LED.

2. The device of claim 1, further comprising a wireless communication connection.

3. The device of claim 2, further comprising a T12 form factor.

4. The device of claim 3, further comprising circuitry to receive commands issued from an app on a computing device to operate an LED inserted into the insertion site.

5. The device of claim 2, further comprising an LED and circuitry configured to:
send a query signal; and
maintain the LED in an off state conditional on receipt of an all clear signal in response to the query signal.
